(19) United States
(12) Patent Application Publication
(10) Pub. No.: US 2008/0149256 A1
(43) Pub. Date: Jun. 26, 2008

(54) Method and apparatus to minimize adhesive induced distortion

(75) Inventors: Pei-Chung Wang, Troy, MI (US); Wayne W. Cai, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/960,902

(22) Filed: Dec. 20, 2007

Related U.S. Application Data
(60) Provisional application No. 60/871,238, filed on Dec. 21, 2006.

(51) Int. Cl. B32B 37/00

(52) U.S. Cl. 156/92; 156/321

(57) ABSTRACT

A method to minimize adhesive induced distortion between heat cured adhesively bonded sheet materials, includes applying a layer of heat curable adhesive between the two sheets; installing a self-piercing rivet or clinching the sheets to connect the sheets; and heating the sheets to cure the adhesive so that the adhesive and the rivet or clinching connection counterbalance the stresses tending to distort the sheets. The heating to cure the adhesive can occur prior to or after the connecting of the sheets by the rivet or clinching. If the sheets are of dissimilar metals having different coefficients of expansion, then the self-piercing rivet is installed or the clinching is performed from the direction to first enter the sheet having the lower coefficient of thermal expansion. If the sheets are of similar metals of different thickness, then the self-piercing rivet is installed or the clinching is performed from the direction to first enter the thicker of the sheets.

This application claims priority of U.S. Provisional Patent Application 60/871238, filed Dec. 21, 2006, entitled Method and Apparatus to Minimize Adhesive Induced Distortion.

### FIELD OF THE INVENTION

The present invention relates the joining together of metal or polymer composite sheets by heat curable adhesive bonding and more particularly to a method for minimizing adhesive induced distortion.

### BACKGROUND OF THE INVENTION

It is desirable in the manufacture of motor vehicle sheet assemblies, as well as other article of manufacture to bond together dissimilar sheet materials. For example it may be desirable to construct a sheet assembly that includes a sheet of steel and a sheet of aluminum or magnesium or composite. Adhesive bonding is a well known method for attaching the sheets and often employs a heat curable adhesive. However, as the two dissimilar materials are cured at elevated temperature, and then cooled to room temperature, there may be residual stresses, with resultant part distortion or bond stressing due to mismatch in thermal coefficient of expansion. Similar distortion and bond stressing results when differing thicknesses of the same material are adhesively bonded.

### SUMMARY OF THE INVENTION

A method to minimize adhesive induced distortion between heat cured adhesively bonded sheets of metal or polymer composite, includes applying a layer of heat curable adhesive between the two sheets; installing a self-piercing rivet or clinching the sheets to connect the sheets; and heating the sheets to cure the adhesive so that the adhesive and the rivet or clinching connection counterbalance the stresses tending to distort the sheets. The heating to cure the adhesive can be performed either prior to or after the connecting of the sheets by the rivet or clinching. If the sheets are of dissimilar metals having different coefficients of expansion, then the self-piercing rivet is installed or the clinching is performed from the direction to first enter the sheet having the lower coefficient of thermal expansion. If the sheets are of similar metals of different thickness, then the self-piercing rivet is installed or the clinching is performed from the direction to first enter the thicker of the sheets.

### BRIEF DESCRIPTION OF THE DRAWINGS

The present invention will become more fully understood from the detailed description and the accompanying drawings, in which:

FIG. 1 is a section view taken through two metal sheets of dissimilar material and having a layer of heat curable adhesive therebetween;

FIG. 2 is a section view taken through the metal sheets and a tool and showing a self-piercing rivet being installed in the metal sheets;

FIG. 3 is a section view showing the installed rivet.

FIG. 4 is a section view taken through two metal sheets of different thickness and having a layer of heat curable adhesive therebetween;

FIG. 5 is a section view taken through the metal sheets of FIG. 4 and a tool and showing a self-piercing rivet being installed in the metal sheets; and,

FIG. 6 is a section view showing the installed rivet.

### DETAILED DESCRIPTION OF THE EXEMPLARY EMBODIMENTS

The following description of certain embodiments is merely exemplary in nature and is not intended to limit the invention, its application, or uses.

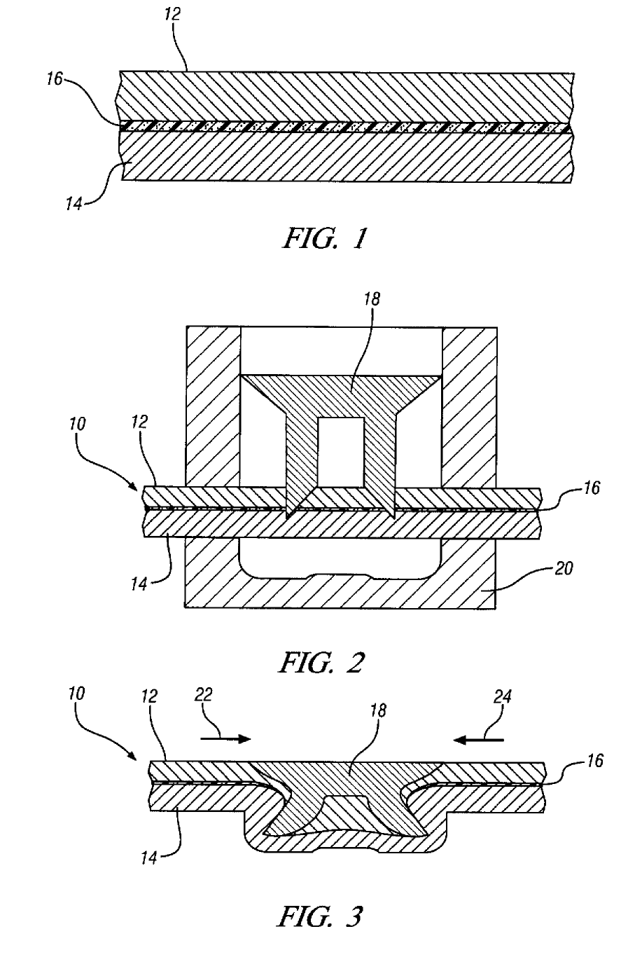

As seen in FIG. 1, a sheet assembly is comprised of two dissimilar metals. The sheet assembly includes a first sheet 12 and a second sheet 14. For example, the upper first sheet 12 is steel and the bottom second sheet 14 is aluminum or magnesium.

In FIG. 1 a heat curable adhesive 16 is applied between the first sheet 12 and the second sheet 14, and then the sheets 12 and 14 are heated, most commonly in a paint curing oven, to cure the adhesive 16. The paint oven typically heats the sheets 12 and 14 to a temperature of several hundred degrees for a period of 20 minutes. The heating of the sheets 12 and 14 causes thermal expansion, the extent of such expansion being in proportion to the coefficient of thermal expansion of the metal, with the result being that the second sheet 14 of aluminum or magnesium will have expanded to a greater extent than the steel first sheet 12 as aluminum and magnesium have a higher coefficient of expansion than steel. During the heating the adhesive 16 is cured. Then, upon cooling of the sheets to room temperature, there will be residual stresses in the part, with resultant part distortion or bond stressing due to the difference in thermal coefficient of expansion. In particular, the stresses will tend to distort the part of FIG. 1 so that its center will bow upwardly. The extent of such distortion will depend upon many factors, such as the extent to which the ends of the first and second sheets have been constrained by their attachment to adjacent structures, such as in the case of the part being a sheet that is welded into a vehicle body.

According to the invention, FIG. 2 shows a sheet assembly 10 including a top first sheet of steel 12 and a bottom second sheet of aluminum 14 with a layer of heat curable adhesive 16 therebetween. The sheets are placed in a tool 20 for the installation of a fastener, in particular a self-piercing rivet 18.

FIG. 3 shows the installed condition of the self-piercing rivet 18 that has been driven through the steel first sheet 12 and into the aluminum second sheet 14. Entry of the self-piercing rivet 18 tends to draw the material of the steel first sheet 12 inwardly in the direction of arrows 22 and 24, and thereby stresses the steel first sheet 12 by introducing distortive stresses due to the flow of material at the spot where the self-piercing rivet 18 enters the sheets. Since the steel first sheet 12 is deformed by the self-piercing rivet 18 more than the aluminum second sheet 14 is deformed, the difference in metal flow and stress will compensate for and counterbalance the stress and distortion induced by the curing of the adhesive 16. Thus, the self-piercing rivet 18 is installed into the sheet that has the material with the lower coefficient of thermal expansion, in this case the steel first sheet 12. Thus, with the proper design of the self-piercing rivet 18, including its geometry and dimensions, and the proper selection of rivet location and direction and number, the distortion inducing stresses can be counterbalanced within the sheet assembly 10. In addition, the self-piercing rivet 18 will assist the adhesive 16 in achieving a permanent attachment between the two sheets. The self-piercing rivet 18 can be installed either prior to the curing of the adhesive 16 in the oven or after the curing of the adhesive 16 in the oven

Furthermore, it will be understood that sheet metal clinching can be used as an alternative to the installation of the self-piercing rivet, in which case the punch for performing the clinching will first enter the sheet having the material of the lower coefficient of expansion. Sheet metal clinching is well known, and employs a punch which enters one of the sheets to displace the sheets into a die cavity that backs up the other sheet. Thus metal of the two sheets is deformed to make a strong interlocking joint without need for installation of a separate fastener. One example of a commercially available clinching system is the Tog-L-Lok sheet metal joining system available from BTM Corporation, Marysville, Mich.

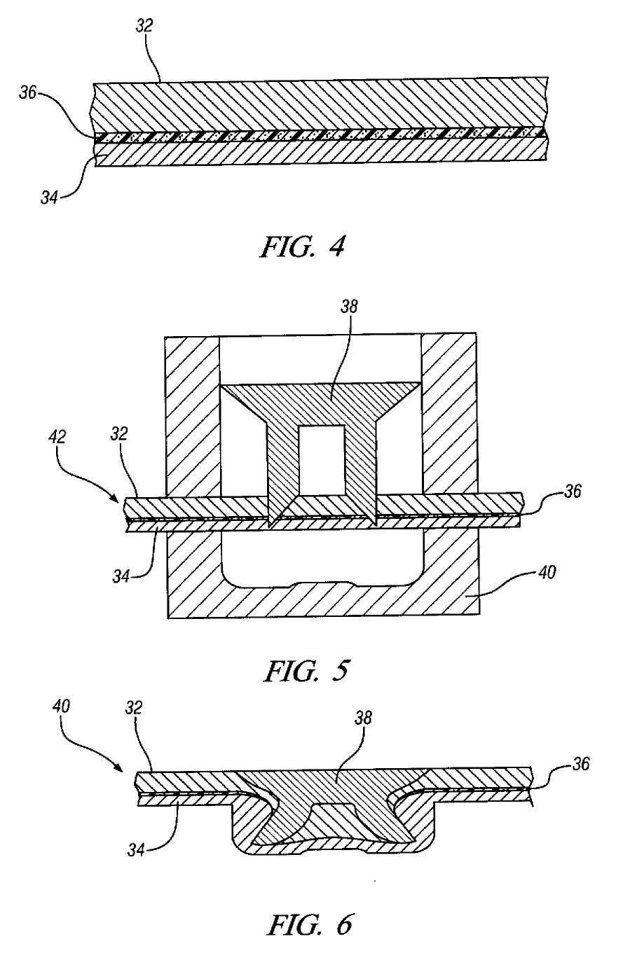

The invention herein may also be employed in the case of adhesive bonding of two sheets of similar material, for example steel, but of different thickness. Referring to FIG. 4, a thick steel first sheet 32, a layer of heat curable adhesive 36 and a thinner steel second sheet 34 are shown. In FIG. 5 a self-piercing rivet 38 is being installed via tool 40 through the thick first sheet 32 into the thinner second sheet 34 of a sheet assembly 42. Upon heating to cure the adhesive 36, such a construction will tend to warp toward the thinner plate and accordingly the self-piercing rivet 38 is installed from the thicker sheet to the thinner sheet to compensate for the adhesive induced distortion.

The self-piercing rivet can be installed either before the adhesive is cured or after the adhesive is cured.

The foregoing description of the invention is merely exemplary in nature and, thus, variations thereof are intended to be within the scope of the invention. In the case of a large and complex shaped sheet assembly, a plurality of such rivets or clinched attachments will be employed at selected locations and spacing in order to compensate for the distortion. The number of such attachments will be dependent on a number of factors, such as the extent to which the edges of the sheet assembly are constrained during the heating, and the choice of materials and thickness of the materials. And the invention can be employed when two or more sheets are stacked with curable adhesive used to join the sheets. Although the drawings herein show the example of metal sheets, one or both of the sheets can be of a polymer composite material.

What is claimed is:

1. A method to minimize adhesive induced distortion between heat cured adhesively bonded sheets, comprising:
applying a layer of heat curable adhesive between the two sheets;
installing a self-piercing rivet or clinching the sheets to connect the sheets;
and heating the sheets to cure the adhesive;
whereby the adhesive and the rivet or clinching connection counterbalance the stresses tending to distort the sheets.

2. The method of claim 1 further comprising installing the self-piercing rivet or clinching the sheets prior to heating the sheets.

3. The method of claim 1 further comprising installing the self-piercing rivet or clinching the sheets after heating the sheets.

4. The method of claim 1 further comprising said sheets being of dissimilar materials having different coefficients of expansion and the self-piercing rivet is installed or the clinching is performed from the direction to first enter the sheet having the lower coefficient of thermal expansion.

5. The method of claim 1 further comprising said sheets being of similar materials of different thickness and the self-piercing rivet is installed or the clinching is performed from the direction to first enter the thicker of the sheets.

6. A method to minimize adhesive induced distortion between heat cured adhesively bonded sheets, comprising:
providing at least two sheets of metal having differing coefficients of thermal expansion;
applying a layer of heat curable adhesive between the sheets;
installing a self-piercing rivet or clinching the sheets to connect the sheets, said self-piercing rivet being installed or said clinching being performed in the direction to first enter the sheet having the lower coefficient of expansion.;
and heating the sheets to cure the adhesive;
whereby the adhesive and the rivet or clinching connection counterbalance the stresses tending to distort the sheets.

7. The method of claim 1 further comprising installing the self-piercing rivet or clinching the sheets prior to heating the sheets.

8. The method of claim 1 further comprising installing the self-piercing rivet or clinching the sheets after heating the sheets.

9. A method to minimize adhesive induced distortion between heat cured adhesively bonded sheets, comprising:
providing at least two sheets of similar material having differing thickness;
applying a layer of heat curable adhesive between the sheets;
installing a self-piercing rivet or clinching the sheets to connect the sheets, said self-piercing rivet being installed or said clinging being performed in the direction to first enter the thicker sheet;
and heating the sheets to cure the adhesive;
whereby the adhesive and the rivet or clinching connection counterbalance the stresses tending to distort the sheets.

10. The method of claim 1 further comprising installing the self-piercing rivet or clinching the sheets prior to heating the sheets.

11. The method of claim 1 further comprising installing the self-piercing rivet or clinching the sheets after heating the sheets.
